(19) United States
(12) Patent Application Publication
(10) Pub. No.: US 2019/0164458 A1
(43) Pub. Date: May 30, 2019

(54) SELF-ILLUMINATING PATCH

(71) Applicant: William L. Schey, Chicago, IL (US)

(72) Inventor: William L. Schey, Chicago, IL (US)

(21) Appl. No.: 16/196,495

(22) Filed: Nov. 20, 2018

Related U.S. Application Data
(60) Provisional application No. 62/592,581, filed on Nov. 30, 2017.

(51) Int. Cl. G09F 13/20; C09J 7/20; G09F 3/10; G09F 3/02

(52) U.S. Cl. CPC G09F 13/20; C09J 7/20; G09F 2003/0282; G09F 3/02; G09F 3/10

(57) ABSTRACT

A self-illuminating patch to be worn on or in close proximity to a person. The patch has an exterior layer of phosphorescent material that becomes self-illuminating in the dark. The exterior phosphorescent layer has alpha numeric or other graphic indicia printed on it using ultraviolet curable ink. A removable backing layer is adhesively attached to the phosphorescent layer and is removed to expose an adhesive layer on the back of the phosphorescent layer. This allows the patch to be secured onto a person's clothing, backpack, or other item.

### CROSS-REFERENCE TO RELATED APPLICATIONS

This application is based on and claims priority of provisional patent application Ser. No. 62/592,581 filed Nov. 30, 2017.

### FIELD OF THE INVENTION

The present invention relates to a safety device worn by a person at night. There are far too many accidents occurring at night or in poor light conditions between pedestrians and between pedestrians and vehicles. The simple reason is that in dimly lit places or due to poor visibility, the pedestrian and/or motorist does not see the other pedestrian until it too late to avoid him or her. Furthermore, in today's technological world, the pedestrians and motorists are easily distracted with their accessories such as mobile devices, radios, navigation systems, dashboard displays, all of which present additional safety hazards when walking or driving. Thus, there is needed a device that can be worn by the pedestrian to attract attention to himself/herself so that the other pedestrians and/or motorist have plenty of time to avoid an accident.

Applicant's invention and solution to this problem is a patch that becomes self-illuminating at night or in the dark and which can be easily seen by other pedestrians and/or motorists in poor visibility conditions. This invention minimizes the risk of possible pedestrian/pedestrian and/or vehicle/pedestrian accidents that occur due to the fact that a pedestrian and/or motorist may not see the other due to poor visibility.

### SUMMARY OF THE INVENTION

Applicant's invention is a patch that has one layer of phosphorescent material that becomes self-illuminating at night or in the dark and which can be easily seen by other pedestrians and/or motorists in poor visibility conditions. The phosphorescent layer has alpha numeric or other graphic indicia printed on it. A removable backing layer is adhesively attached to the phosphorescent layer and is removed to expose an adhesive layer on the back of the phosphorescent layer. This allows the patch to be secured onto a person's clothing, backpack, or other item that is in close proximity to the person. Alternatively, an intermediary layer can be disposed between the removable backing layer and the phosphorescent layer. The intermediary layer is attached to the back of the phosphorescent layer and the backing layer is removably attached to the back of the intermediary layer. There is an adhesive layer on the back side of the intermediary layer that is used to attach the patch to the user or other item.

### BRIEF DESCRIPTION OF THE DRAWINGS

The Description of the Preferred Embodiment will be better understood with reference to the following figures:

FIG. 1 is a front view of the inventive patch and, in particular, the front layer.

FIG. 2 is a top perspective view of the inventive patch and, in particular, illustrating the integration of the front layer to the backing layer.

FIG. 3 is a cross sectional view taken along lines 3-3 of FIG. 1.

FIG. 4 is a top perspective view of an alternate embodiment of the inventive patch and, in particular, illustrating the integration of the front layer, intermediary layer and backing layer.

FIG. 5 is cross sectional view of the alternate embodiment of the patch in which there is an intermediary layer between the phosphorescent layer and the backing layer.

### DETAILED DESCRIPTION OF THE PREFERRED EMBODIMENT

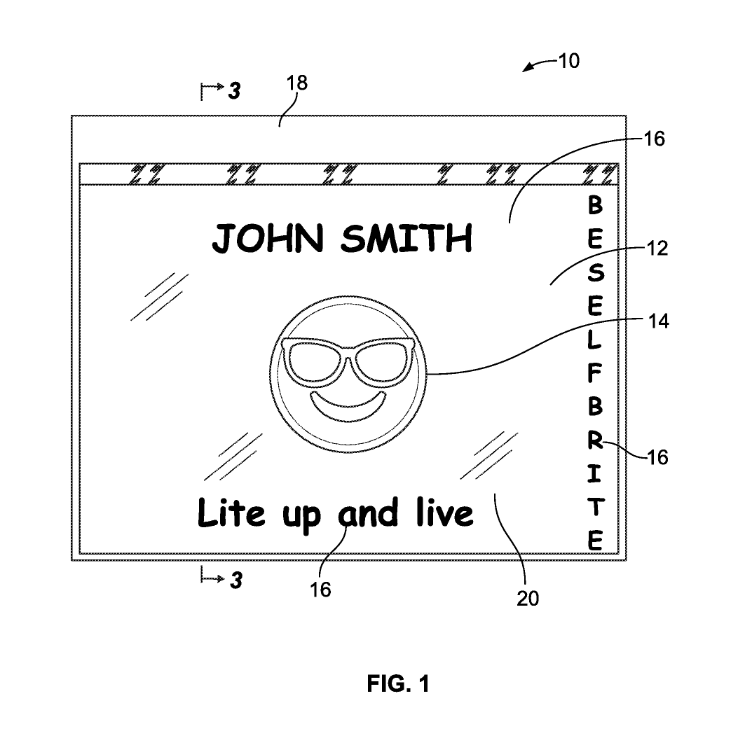

Turning first to FIG. 1, there is illustrated an inventive patch 10 having a front layer 12. Although this front layer 12 is depicted in a rectangular shape, this is for illustrative purposes only as the front layer 12 of inventive patch 10 can be depicted or used in any shape or size.

In the preferred embodiment, this front layer 12 is made of a phosphorescent material, which is a special kind of luminescence. Phosphorescent materials absorb light energy such as the ultraviolet light emitted by the sun or by lamps and then later emits this energy in the form of light, which can be visible after dark. Alternatively, the front layer 12 may be made of any other type of photoluminescence or other material known to one skilled in that art that can likewise perform this same function as described herein. The front layer 12 can also be made of any color, but preferably will be a bright color, such as bright yellow, bright red or bright green, such that the inventive patch 10 can be easily be seen at night or in poor visibility conditions.

Additionally, as illustrated, this front layer 12 can visually communicate with others using indicia 14 or other information 16. In non-limiting examples, the indicia 14 is a smiley face sticker, emoji, or other graphical image as desired by the user; and the information 16 is the person's surname, slogan, trademark, advertisement, or any other type of alpha-numeric information that the user desires to impart to the inventive patch 10. The front layer 12 may be, but not necessarily, covered in a clear or transparent protective layer 20 that will generally be made from a clear plastic sheet or can be applied as a liquid or spray to cover the front layer with a protective layer.

The indicia printed on the exterior surface of the front layer 12 is an ultraviolet ink. It can be applied by hand or by a printer that may have multiple images and alpha-numeric letters and numbers that can be retrieved. The retrieved image is then printed on the exterior surface of the front layer 12. The printed image is then subjected to an ultraviolet light source which cures the image onto the exterior surface of the front layer 12.

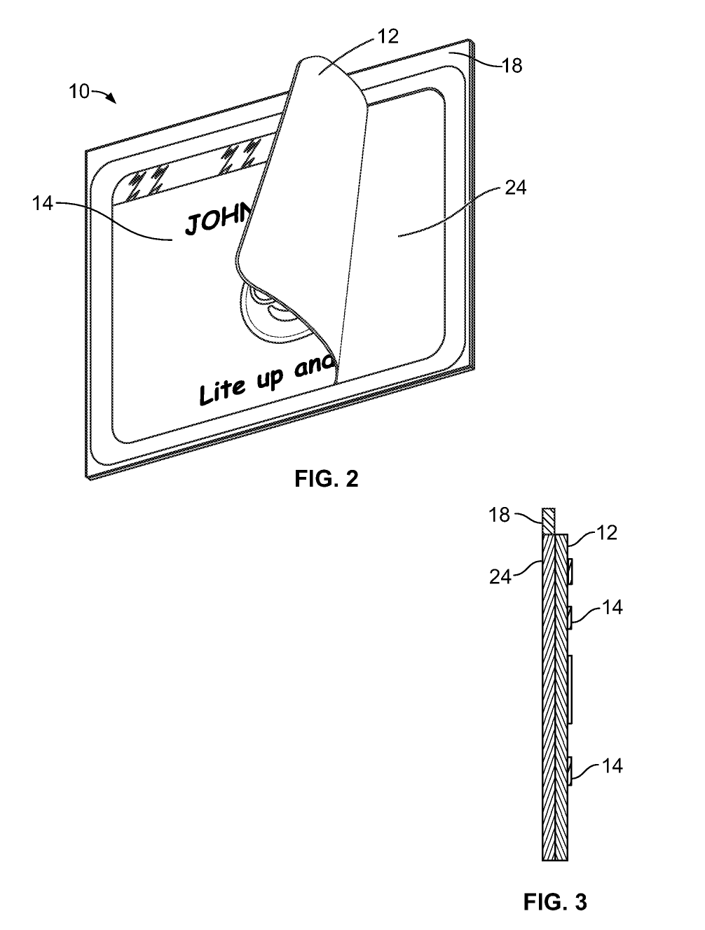

Turning to FIG. 2, there is illustrated the layers of the inventive patch 10. There is a backing layer 24 removably attached with adhesive material to the interior side of the front layer 12. The adhesive can be placed on either the backing layer 24 or the interior side of the front layer 12. This allows the backing layer to be easily peeled away from the front layer 12 which allows the patch to be affixed to an article of clothing or another article, such as a backpack.

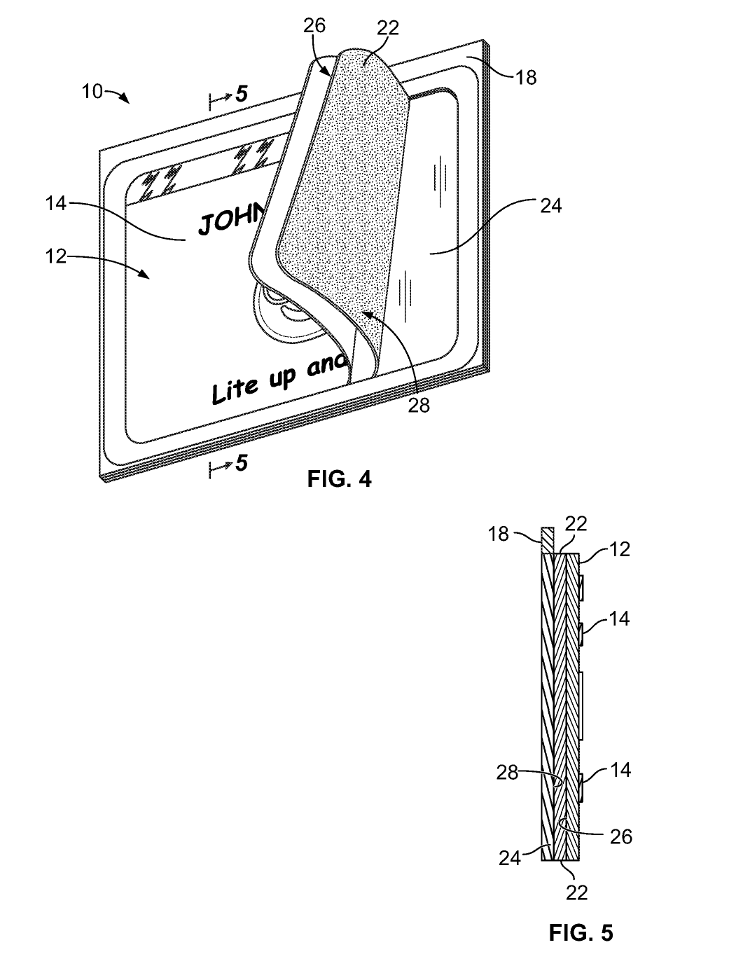

In an alternate embodiment as seen in FIG. 4, there is an intermediary layer 22, placed between the backing layer 24 and the front layer 12. The intermediary layer 22 has a first side 26 that is secured, using an adhesive or any other means known to one skilled in the art, to the non-visible or interior side of the front layer 12. There is a second side 28 that is covered in an adhesive material which is then affixed to the backing layer 24. Situated at the top of the backing layer 24 is a flap 18. The backing layer 24 can be made from cardboard, heavy paper, cloth or other suitable material that meets the criteria of the invention.

Additionally, the backing layer 24 may be a component part of the photoluminescence paper or front layer 12 and the exterior or back side of the backing layer 24 can have adhesive applied for affixing the light patch to the user. A removable covering covers the exterior or back side of the backing layer 24. When it is removed, the adhesive on the exterior is exposed and the patch 10 can be affixed to the user. This embodiment eliminates the need for an intermediary layer 22. In this manner, the inventive patch 10 is a completed product in a form suitable for sale and distribution.

In use, the front layer 12 of the inventive patch 10 is exposed to light energy such as the ultraviolet light emitted by the sun or by lamps. In the preferred embodiment, and depending upon the size and shape of the inventive patch, the longer exposure to the light energy the better the results and the longer the inventive patch 10 will emit energy in the form of light which can be visible after dark.

Pulling on the flap 18 in a direction away from the front layer 12 will allow the backing layer 24 to be peeled off or removed from the intermediary layer 22 thereby exposing the second side 28 that is covered in the adhesive material. This second side 28 covered in the adhesive material is then pressed against or applied to the user. In this manner, the inventive patch 10 becomes secured to the person's clothing or other item, such as a back pack, worn by or in close proximity to the person and placed in a location potentially most visible to the other pedestrians or motorists.

Thus, there has been provided Applicant's unique self-illuminating inventive patch. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the disclosure contained herein.

What is claimed is:

1. A self-illuminating patch comprising:
a flexible first layer having an exterior surface and an interior surface, the exterior surface comprising a phosphorescent layer presented to the ambient environment,
printed indicia on the exterior surface of the first layer which is visible from the ambient environment,
an adhesive layer applied to the interior surface of the first layer,
a protective cover layer applied over the adhesive layer on the interior surface of the first layer,
whereby when the protective layer is removed from the adhesive layer the patch can be affixed to an article so that the phosphorescent layer emits an image in the dark.

2. The self-illuminating patch of claim 1 wherein the printed indicia comprises an ultraviolet curable ink that forms an image.

3. The self-illuminating patch of claim 1 and further comprising an intermediary layer disposed between the first layer and the protective layer, the intermediary layer having an exterior surface attached to the interior surface of the first layer and having an interior surface attached to the protective layer by an adhesive, the protective layer removable from the interior surface of the intermediary layer to expose the adhesive whereby the intermediary layer can be affixed to an article.

4. The self-illuminating patch of claim 2 wherein the intermediary layer is a flexible layer.

5. A method of making a self-illuminating patch comprising the steps of:
selecting a first flexible layer of a phosphorescent material, the first flexible layer having an exterior surface and an interior surface,
applying a printed indicium to the exterior surface of the first flexible layer,
applying an adhesive to the interior surface of the first flexible layer,
covering the adhesive with a removable protective layer,
removing the protective layer, and
applying the self-illuminating patch to an article by means of the adhesive.

6. The method of claim 5 and the additional step of applying an intermediary flexible layer between the first flexible layer and the protective layer.

7. A method of making a self-illuminating patch comprising the steps of:
a. obtaining a sheet of photoluminescent paper having an exterior and interior surface and a removable backing sheet adhesively attached to the interior surface of the photoluminescent paper;
b. applying a ultraviolet curable ink image to the exterior surface of the sheet of photoluminescent paper;
c. exposing the sheet of photoluminescent paper to an ultraviolet light source for curing the ink image;
d. removing the backing sheet; and
e. affixing the interior surface to an article by means of the adhesive.
